(19) United States
(12) Patent Application Publication
(10) Pub. No.: US 2008/0295726 A1
(43) Pub. Date: Dec. 4, 2008

(54) METHOD AND APPARATUS FOR PREDICTING A DISCHARGE RATE OF AN ENERGY STORAGE SYSTEM

(76) Inventors: Charles Earl Cooper, Erie, PA (US); Julie Ann Crosscut, McKean, PA (US)

Correspondence Address: JOHN S. BEULICK (12729 +2000);ARMSTRONG TEASDALE LLP, ONE METROPOLITAN SQUARE, SUITE 2600, SAINT LOUIS, MO, 63102-2740, US

(21) Appl. No.: 11/756,723

(22) Filed: Jun. 1, 2007

(51) Int. Cl. H02J 7/00

(52) U.S. Cl. 105/50; 320/132; 701/29

(57) ABSTRACT

A method for predicting a low battery voltage condition includes calculating a minimum battery capacity required to start an engine, determining a first capacity of a battery at a first time, determining a second capacity of the battery at a second time, and predicting, based on the first and second determined capacities, when a remaining capacity of the battery will be less than the minimum battery capacity. A control system programmed with the above method and a locomotive included the programmed control system are also described herein.

### BACKGROUND OF THE INVENTION

This invention relates generally to an energy storage system, and more particularly to a method and apparatus for predicting the discharge rate of an energy storage system utilized in a locomotive.

Railroad locomotives typically include a diesel engine that is coupled to a traction drive system that provides the propulsion force for the locomotive. To start the diesel engine, locomotives include an energy storage system that is utilized to start the diesel engine and to provide electrical power to various devices installed on the locomotive. During operation, an alternator driven by the diesel engine, continuously recharges the energy storage system to ensure that the energy storage system remains charged to a predetermined voltage level.

However, when the diesel engine is not running, the energy storage system may still be utilized to provide power to the various electrical loads. As a result, the voltage level of the energy storage system may decrease to a voltage level that is insufficient to start the diesel engine. In this case, a road failure alert may be issued instructing maintenance personnel that the energy storage system requires charging before the diesel may be started and the locomotive is placed back in service. Additionally, the voltage drain on the energy storage system, caused by the connected loads, may be sufficient to cause the energy storage system to fail, i.e. the energy storage system is unable to hold a charge when connected to a charging system.

### BRIEF DESCRIPTION OF THE INVENTION

In one aspect, method for predicting a low battery voltage condition is provided. The method includes calculating a minimum battery capacity required to start an engine, determining a first capacity of a battery at a first time, determining a second capacity of the battery at a second time, and predicting, based on the first and second determined capacities, when a remaining capacity of the battery will be less than the minimum battery capacity.

In another aspect, a locomotive control system is provided. The locomotive control system is programmed to calculate a minimum battery capacity required to start an engine, determine a first capacity of a battery at a first time, determine a second capacity of the battery at a second time, and predict, based on the first and second determined capacities, when a remaining capacity of the battery will be less than the minimum battery capacity.

In a further aspect, a train locomotive is provided. The train locomotive includes an engine, at least one battery utilized to start the engine, and a control system coupled to the battery. The control system is programmed to calculate a minimum battery capacity required to start an engine, determine a first capacity of a battery at a first time, determine a second capacity of the battery at a second time, and predict, based on the first and second determined capacities, when a remaining capacity of the battery will be less than the minimum battery capacity.

### BRIEF DESCRIPTION OF THE DRAWINGS

FIG. 1 is a simplified block diagram of an exemplary locomotive;

FIG. 2 is a flow chart illustrating an exemplary method for predicting a low battery voltage condition; and

FIG. 3 is a graphical illustration of the energy storage system shown in FIG. 1 during typical operation.

### DETAILED DESCRIPTION OF THE INVENTION

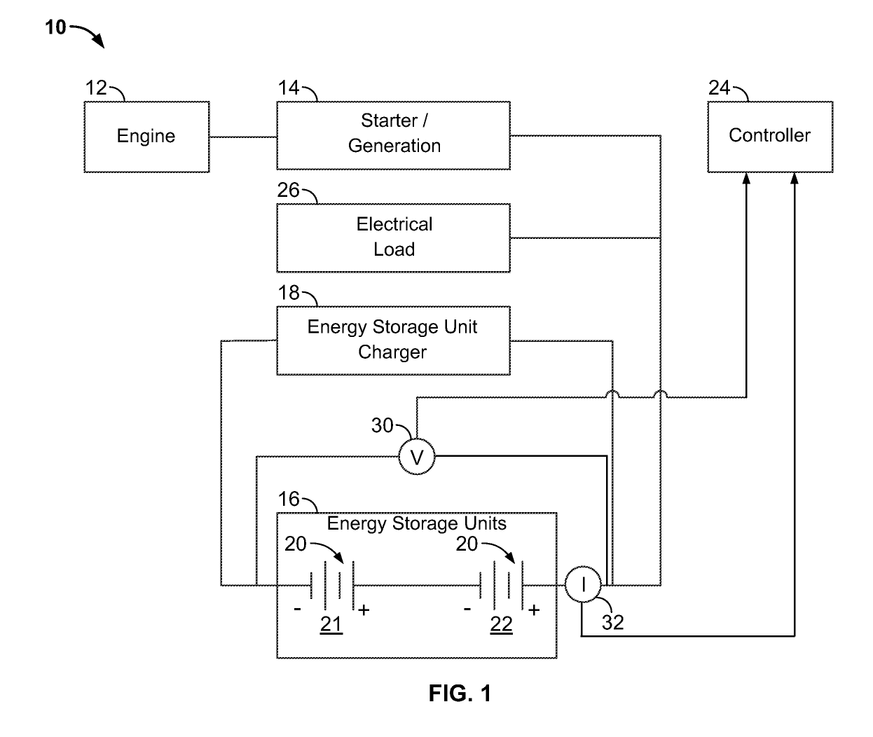

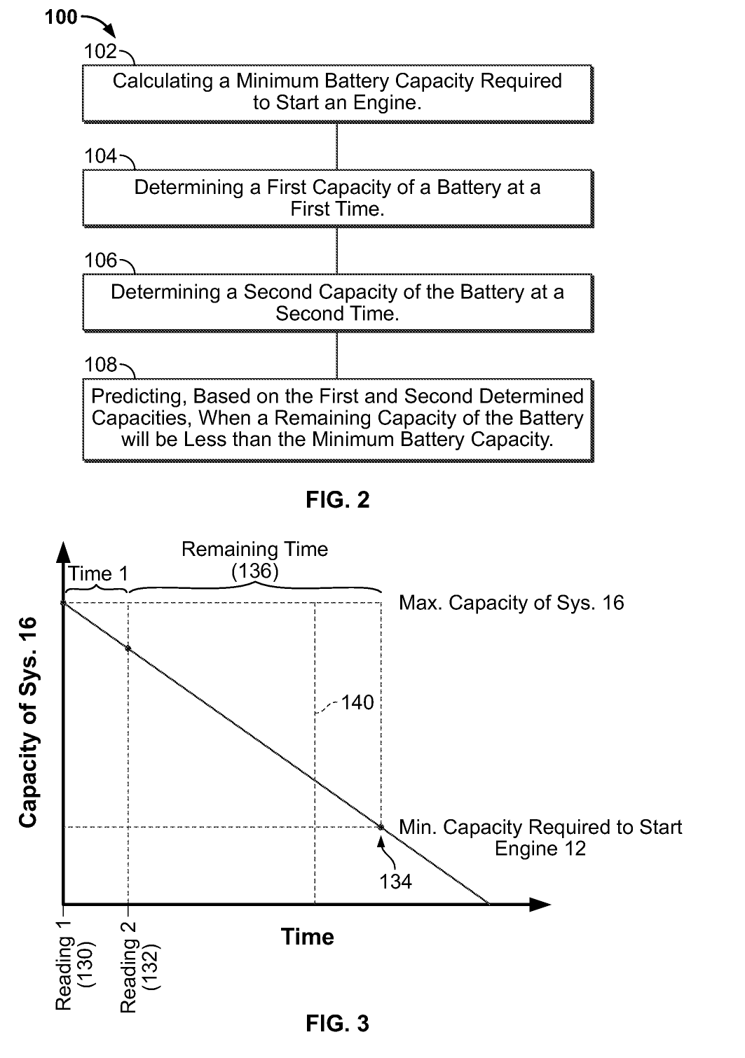

FIG. 1 is a simplified block diagram of an exemplary locomotive 10 that includes an engine 12, a starter/generator 14, at least one energy storage unit 16, and an energy storage unit charger 18. In the exemplary embodiment, energy storage system 16 is implemented using a plurality of batteries 20. For example, in the embodiment shown in FIG. 1, energy storage system 16 includes a first battery 21 and a second battery 22. Optionally, energy storage system 16 includes only one battery 20 or may include two or more individual batteries 20 as well as associated external cabling and any associated internal cabling between multiple individual batteries. Each of the one or more individual batteries 20 may be implemented using a lead acid battery, for example. As such, energy storage unit charger 18 may be implemented using a battery charger. Locomotive 10 also includes a controller 24 that is coupled to energy storage unit 16 to perform functions as discussed below.

Controller 24 generally includes at least one computer that is programmed to perform the functions described herein. Computer, as used herein, is not limited to just those integrated circuits referred to in the art as a computer, but broadly refers to a processor, a microprocessor, a microcontroller, a programmable logic controller, an application specific integrated circuit, and another programmable circuit, and these terms are used interchangeably herein.

In one mode of operation, when it is desired to start engine 12, control system 24 is programmed to close a contactor (not shown) such that current from energy storage unit 16 is channeled to starter/generator 14 which functions as a starter to start engine 12 as known in the art. During operation, starter/generator 14 functions as a generator to charge energy storage units 16, or energy storage unit charger 18 may be utilized to charge energy storage units 16.

As discussed above, when engine 12 is not running, energy storage unit 16 may still be utilized to provide power to the various electrical loads, such as electrical loads 24 and 26, for example. As a result, the voltage level of energy storage unit 16 may decrease to a voltage level that is insufficient to start engine 12. More specifically, energy storage units in general are rated based on the quantity of power that may be drawn from the storage unit during various operating conditions. For example, when the energy storage unit 16 is implemented using batteries 20, a designer determines a minimum battery capacity required to start an engine, such as engine 12, and then installs at least one or several batteries having a combined battery capacity to perform this function. However, as discussed above, when engine 12 is not operating, and batteries 20 are still being utilized to drive a load, such as load 26, the voltage or cold cranking amperage capability of batteries 20 may decrease to a level wherein a remaining capacity of batteries 20 is less than the minimum battery capacity required to start engine 12.

As a result, described herein is a method 100 for predicting a low battery voltage condition. Method 100 includes calculating 102 a minimum battery capacity required to start an engine, determining 104 a first capacity of a battery at a first time, determining 106 a second capacity of the battery at a second time, and predicting 108, based on the first and second determined capacities, when a remaining capacity of the battery will be less than the minimum battery capacity. In the exemplary embodiment, method 100 is implemented using an algorithm that is stored on a computer, such as controller 24, for example.

In the exemplary embodiment, calculating a minimum battery capacity required to start an engine includes calculating the minimum battery capacity to start engine 12 which in the exemplary embodiment is a diesel locomotive engine. The minimum battery capacity required to start a locomotive engine is generally determined at the factory or by on-site maintenance personnel based on the size or horsepower rating of the engine being started, and may be different for each locomotive. For example, a first locomotive may include a first energy storage system 16 that includes a series of batteries 20 with a cumulative voltage of approximately twenty-four volts that is utilized to start a first diesel engine having a first horsepower rating. In the first case, the required capacity may be defined as either a minimum voltage required to start the diesel engine, or optionally, as a minimum cranking amperage required to start the diesel engine.

As such, in one exemplary embodiment, the minimum battery capacity to start the diesel engine may be approximately twenty-volts as determined by a voltage sensor 30, or approximately 650 cold cranking amps as determined by a current sensor 32. As shown in FIG. 1, voltage sensor 30 and current sensor 32 are coupled to control system 24 which is programmed to continuously monitor signals generated by voltage sensor 30 and current sensor 32. In another exemplary embodiment, the minimum battery capacity to start the diesel engine may be approximately forty-eight volts as determined by a voltage sensor 30, or approximately 1000 cold cranking amps as determined by a current sensor 32.

It should be realized that the starting capacity of the energy storage system 16 is generally greater than the minimum battery capacity required to start the engine to ensure that energy storage system 16 has sufficient battery capacity to crank or rotate engine 12 for a predetermined amount of time to ensure that engine 12 starts. The minimum battery capacity required to start engine 12, for a particular locomotive 10, is then stored in controller 24 as either a voltage setpoint or a current setpoint based on the a predetermined setpoint in a control algorithm.

During operation, the excess energy storage system capacity may then be utilized to operate various accessories, such as control system 24 and electrical load 26, when engine 12 is not in operation. In this mode of operation, the operator or remote personnel are generally unaware of the energy storage system capacity that has been expended to operate the accessories 26. Accordingly, method 100 further includes determining 104 a first capacity of a battery, such as batteries 20, at a first time, and determining 106 a second capacity of the battery, e.g. batteries 20, at a second time that is different than the first time.

FIG. 3 is a graphical illustration of the energy storage capacity of batteries 20 when engine 12 is not operation. During operation, after locomotive 10 is shutdown by stopping engine 12, a first reading or snapshot 130 of energy storage system 16 is taken, by controller 24, to determine 104 the first capacity of batteries 20, at a first point in time. For example, the first or initial reading 130 is preferably acquired by controller 24 at some time after a command has been transmitted to stop engine 12. Specifically, the first or initial reading is generally acquired after the engine is stopped, the charger is deactivated, and battery voltage has settled to a voltage is approximately equal to the open circuit voltage. In this case, the first or exemplary reading should indicate the maximum or fully charged state of energy storage system 16 or the maximum charge storage system 16 is capable of maintaining.

As discussed above, and shown in FIG. 3, continued operation of the accessories 26 causes the voltage level of energy storage system 16 to gradually decrease to a point wherein the remaining capacity of the energy storage system 16 is less than the minimum capacity required to restart engine 12. Accordingly, method 100 further includes taking a second reading or snapshot 132 of energy storage system 16, utilizing controller 24, to determine 104 a second capacity of batteries 20, at a second point in time. For example, the second reading 132 is preferably acquired by controller 24 at a predetermined time after the first reading 130 is acquired. In this case, the second reading 132 indicates the voltage drop, or reduction in cranking amperage, that has occurred in energy storage system 16 during the time interval that has elapsed between the first and second readings or snapshots. In the exemplary embodiment, the elapsed time or predetermined time between the first reading 130 and the second reading 132 is a predetermined setpoint in the control algorithm and is configurable by an operator or by maintenance personnel. For example, the predetermined time may be set such that the second reading 132 is acquired by controller 24 thirty minutes after the first reading 130 is acquired by controller 24.

Utilizing this information, i.e. the time interval between the first and second readings 130, 132 and the voltage drop between the first and second readings 130, 132, controller 24 is programmed to predict, based on the first and second determined voltages, when a remaining capacity of the energy storage system 16 will be less than the minimum energy capacity required to start engine 12 (shown as item 134 in FIG. 3). For example, as shown in FIG. 3, the algorithm is programmed to extrapolate based on at least two reading or snapshots 130 and 132 the quantity of time that is remaining until the capacity of energy storage system 16 is less than what is required to start engine 12 (shown as item 136 in FIG. 3). Although, the exemplary embodiment describes two readings or snapshots 130, 132 utilized to predict the remaining time, it should be realized that the algorithm may be programmed to utilize n readings or snapshots, wherein n>2, to predict the remaining time.

For example, during operation controller 24 is programmed to acquire a first snapshot 130 of energy storage system 16. In this example, energy storage system 16 is fully charged to twenty-four volts. As such, the first snapshot 1 130 acquired by controller twenty-four indicates a reading of approximately twenty-four volts. Assuming the predetermined time is preset at thirty minutes, controller 24 is programmed to acquire the second reading or snapshot 132 thirty minutes after the first reading or snapshot 130 is acquired. Assuming the second snapshot 132 indicates that the energy storage system 16 has a voltage of 23 volts, i.e. voltage is decreasing by one volt every thirty minutes, and further assuming that the minimum battery capacity required to restart engine 12 is set to twelve volts, the algorithm is programmed to predict that approximately eleven hours after the second reading 132 is acquired, the remaining capacity of the energy storage system 16, i.e. batteries 20, will be less than the minimum battery capacity required to restart engine 12. It should be realized that the voltage levels and time intervals in the previous example or exemplary only and may vary based on the battery capacities and electrical usage for each individual locomotive.

Once the quantity of time that is remaining until the capacity of energy storage system 16 is less than what is required to start engine 12 (shown as item 136 in FIG. 3) is determined, controller 24 is further programmed to generate an advance warning indication that is utilized to notify an operator or maintenance personnel that engine 12 should be restarted to charge energy storage device 16. In the exemplary embodiment, the advance warning indication may be implemented using at least one of a visual indication and an audible indication. For example, assuming the algorithm has predicted that in approximately eleven hours the remaining capacity of the energy storage system 16, i.e. batteries 20, will be less than the minimum battery capacity required to restart engine 12, the visual or audible indication will activate at some predetermined time (shown as 140 in FIG. 3) prior to the expiration of the eleven hour period, i.e. remaining time 136.

In the exemplary embodiment, the advance warning indication is a predetermined setpoint in the control algorithm and is configurable by an operator or by maintenance personnel. For example, if an operator enters a predetermined time 140 of three hours into controller 24, the visual or audio indication will activate three hours prior to the expiration of the remaining time required to restart engine 12. In use, the visual or audio indication is set at a predetermined time that is sufficient to allow an operator adequate time to restart engine 12 prior to expiration of the eleven hour period, i.e. remaining time 136 to avoid a “dead/won't start failure”.

Described herein is an exemplary method and algorithm for predicting a low battery voltage condition in a locomotive. In use, the algorithm is programmed to provide an advance warning indication that the battery on a locomotive that is shut down is approaching a state of discharge where the battery will no longer be capable of cranking the engine. More specifically, during operation after a locomotive engine has been shut down, the algorithm takes snapshots of battery voltages at specified points in time. Based on these snapshots, a rate of discharge is calculated (an assumption of a constant discharge rate is made and the simple linear equation is used). That rate of discharge can then be used to determine at what point in time or at what voltage level the battery will reach its state of charge where it can no longer crank the engine. Based on this calculation, a warning incident can be logged and a request issued to indicate to the customer that the engine needs to be restarted, or the battery requires charging, within a predetermined time period that is set by the customer to avoid a “dead won't start” failure. The predetermined time is configurable and may be set to meet a given customer's need. For example, if the predetermined time is set to three hours, then three hours prior to the battery reaching the state of discharge where it can no longer crank the engine, a visual or audio indication will be transmitted to the customer to indicate that the engine needs to be restarted within three hours.

As a result, the method and algorithm described herein provide an advance warning to a customer that the locomotive battery is reaching a state of charge such that it can't crank the engine. By determining the rate of discharge of the battery, the point at which it will no longer be able to crank can be determined ahead of time and a warning sent out prior to the condition occurring.

While the invention has been described in terms of various specific embodiments, those skilled in the art will recognize that the invention can be practiced with modification within the spirit and scope of the claims.

What is claimed is:

1. A method for predicting a low battery voltage condition; said method comprising:
calculating a minimum battery capacity required to start an engine;
determining a first capacity of a battery at a first time;
determining a second capacity of the battery at a second time; and
predicting, based on the first and second determined capacities, when a remaining capacity of the battery will be less than the minimum battery capacity.

2. A method in accordance with claim 1, wherein determining a first and second capacity further comprises:
determining a first voltage of a battery at a first time;
determining a second voltage of the battery at a second time; and
predicting, based on the first and second determined voltages, when a remaining capacity of the battery will be less than the minimum battery capacity.

3. A method in accordance with claim 1, wherein calculating a minimum battery capacity further comprises:
calculating a minimum battery capacity required to start a diesel locomotive engine; and
determining when the second voltage will be less than the minimum battery capacity required to start the diesel locomotive engine.

4. A method in accordance with claim 1, further comprising:
calculating a rate of discharge of the battery using the first and second determined voltages; and
using the calculated rate of discharge to generate a remaining time indication, wherein the remaining time indication is the amount of time until the second voltage will be less than the minimum battery capacity required to start the engine.

5. A method in accordance with claim 4, further comprising activating an advance warning indication prior to the battery reaching a state wherein the remaining capacity of the battery is less than the minimum battery capacity required to start a diesel locomotive engine.

6. A method in accordance with claim 5, wherein activating an advance warning indication further comprises activating at least one of a visual indication and an audible indication.

7. A method in accordance with claim 1, further comprising notifying an operator prior to the battery reaching a state wherein the remaining capacity of the battery is less than the minimum battery capacity required to start a diesel locomotive engine.

8. A locomotive control system, said control system programmed to:
calculate a minimum battery capacity required to start an engine;
determine a first capacity of a battery at a first time;
determine a second capacity of the battery at a second time; and
predict, based on the first and second determined capacities, when a remaining capacity of the battery will be less than the minimum battery capacity.

9. A locomotive control system in accordance with claim 8, wherein said control system is further programmed to:
determine a first voltage of a battery at a first time;
determine a second voltage of the battery at a second time; and
predict, based on the first and second determined voltages, when a remaining capacity of the battery will be less than the minimum battery capacity.

10. A locomotive control system in accordance with claim 8, wherein said control system is further programmed to:
calculate a minimum battery capacity required to start a diesel locomotive engine; and
determine when the second voltage will be less than the minimum battery capacity required to start the diesel locomotive engine.

11. A locomotive control system in accordance with claim 8, wherein said control system is further programmed to:
calculate a rate of discharge of the battery using the first and second determined voltages; and
use the calculated rate of discharge to generate a remaining time indication, wherein the remaining time indication is the amount of time until the second voltage will be less than the minimum battery capacity required to start the engine.

12. A locomotive control system in accordance with claim 8, wherein said control system is further programmed to activate an advance warning indication prior to the battery reaching a state wherein the remaining capacity of the battery is less than the minimum battery capacity required to start a diesel locomotive engine.

13. A locomotive control system in accordance with claim 12, wherein said control system is further programmed to activate at least one of a visual indication and an audible indication when the advance warning indication is activated.

14. A locomotive control system in accordance with claim 8, wherein said control system is further programmed to notify an operator prior to the battery reaching a state wherein the remaining capacity of the battery is less than the minimum battery capacity required to start a diesel locomotive engine.

15. A train locomotive comprising:
an engine;
at least one battery utilized to start said engine; and
a control system coupled to said battery, said control system programmed to
calculate a minimum battery capacity required to start an engine;
determine a first capacity of the battery at a first time;
determine a second capacity of the battery at a second time; and
predict, based on the first and second determined capacities, when a remaining capacity of the battery will be less than the minimum battery capacity to start the engine.

16. A train locomotive in accordance with claim 15, wherein said control system is further programmed to:
determine a first voltage of a battery at a first time;
determine a second voltage of the battery at a second time; and
predict, based on the first and second determined voltages, when a remaining capacity of the battery will be less than the minimum battery capacity.

17. A train locomotive in accordance with claim 15, wherein said control system is further programmed to:
calculate a minimum battery capacity required to start a diesel locomotive engine; and
determine when the second voltage will be less than the minimum battery capacity required to start the diesel locomotive engine.

18. A train locomotive in accordance with claim 15, wherein said control system is further programmed to:
calculate a rate of discharge of the battery using the first and second determined voltages; and
use the calculated rate of discharge to generate a remaining time indication, wherein the remaining time indication is the amount of time until the second voltage will be less than the minimum battery capacity required to start the engine.

19. A train locomotive in accordance with claim 15, wherein said control system is further programmed to activate an advance warning indication prior to the battery reaching a state wherein the remaining capacity of the battery is less than the minimum battery capacity required to start a diesel locomotive engine.

20. A train locomotive in accordance with claim 19, wherein said control system is further programmed to activate at least one of a visual indication and an audible indication when the advance warning indication is activated.
